(19) United States
(12) Patent Application Publication
(10) Pub. No.: US 2010/0070546 A1
(43) Pub. Date: Mar. 18, 2010

(54) Providing Local File Storage within a Java Server Environment

(76) Inventors: Daniel P. Meyer, Downingtown, PA (US); Thomas A. Salter, Hatfield, PA (US); Allen Albinsky, Langhome, PA (US)

Correspondence Address: UNISYS CORPORATION, UNISYS WAY, MAIL STATION: E8-114, BLUE BELL, PA, 19424, US

(21) Appl. No.: 12/209,520

(22) Filed: Sep. 12, 2008

(51) Int. Cl. G06F 17/30

(52) U.S. Cl. 707/831; 707/E17.01

(57) ABSTRACT

A local file storage is provided for a virtual machine running on a server. A common directory is created on the local file storage, including files usable by the virtual machine. A private directory is created on the local file storage, including user files accessible only by a single user of the virtual machine, wherein each virtual machine user has a separate private directory. The common directory and the private directory are accessed via the virtual machine and a common nomenclature, whereby the implementation of the common directory and the private directory on the local file storage is hidden from the user. The virtual machine may be accessed through a host environment, and each host environment user has a separate private directory.

### FIELD OF INVENTION

The present invention is related to local file storage for a virtual machine, and in particular, to providing local file storage for a Java server environment.

### BACKGROUND

An application written in the Java programming language is designed to be executed on a Java Virtual Machine (JVM). There are different JVMs for different computer operating systems, such as Microsoft Windows, Mac OS, Linux, and Master Control Program (MCP).

In an MCP environment, the MCP operating system controls all job initiation and termination, data access (file input/output (IO) and management), and network access (sockets). Applications are deployed to the MCP file system and sockets are opened from the MCP environment. Java command parameters are entered on the MCP to initiate a “Java proxy” on the MCP. In this sense, a proxy is a software agent that performs a function or operation on behalf of another application or system while hiding the details involved. In this case, the other application is the JVM, which is subsequently initiated on a Java server. The command parameters entered on the MCP are passed to the JVM. Depending on the implementation, the Java server may be running on a specialized processor (e.g., a Java processor) or on a different operating system (e.g., a Windows system).

### SUMMARY

The MCP file system is used for all data and user Java programs. The Windows file system is used for temporary files or for fixed content, such as Windows font files, Java archive (JAR) files, and files to support the execution environment.

One type of JVM is an “eMode JVM,” which supports the ALGOL programming language and its extensions. In the eMode JVM, a getFileSystem( ) Java native method is used to create the MCPFileSystem in the Java Runtime Environment (JRE). The MCPFileSystem is a modified version of the WinNTFileSystem that supports a dual MCP/Windows file system environment, allowing directory management functions to apply to either the MCP file system or the Windows file system. A modified version of the standard C Runtime Library is used to support the dual file system, allowing calls to MCP or to Windows depending on the target file name.

The Windows environment on which the JVM is actually ran is integrated with the MOP environment. In particular, files, sockets, native functions (i.e., Java Native Interface (JNI)), and other functions are supported by software running in both the Windows environment and the MCP environment.

For file IO and file management functions, the JVM uses the underlying C/C++ functions, e.g., open, read, and printf. To avoid extensive JVM patching, the underlying C Runtime library is modified to call the appropriate OS environment to allow JVM IO to function with minor modifications.

### BRIEF DESCRIPTION OF THE DRAWINGS

A more detailed understanding of the invention may be had from the following description of a preferred embodiment, given by way of example, and to be understood in conjunction with the accompanying drawings, wherein:

FIG. 1 is a block diagram showing a construction of a host environment interacting with a Java server environment;

FIG. 2 is a flowchart showing the operation of the environment shown in FIG. 1; and

FIG. 3 is a flowchart showing the operation of a worker thread.

### DETAILED DESCRIPTION

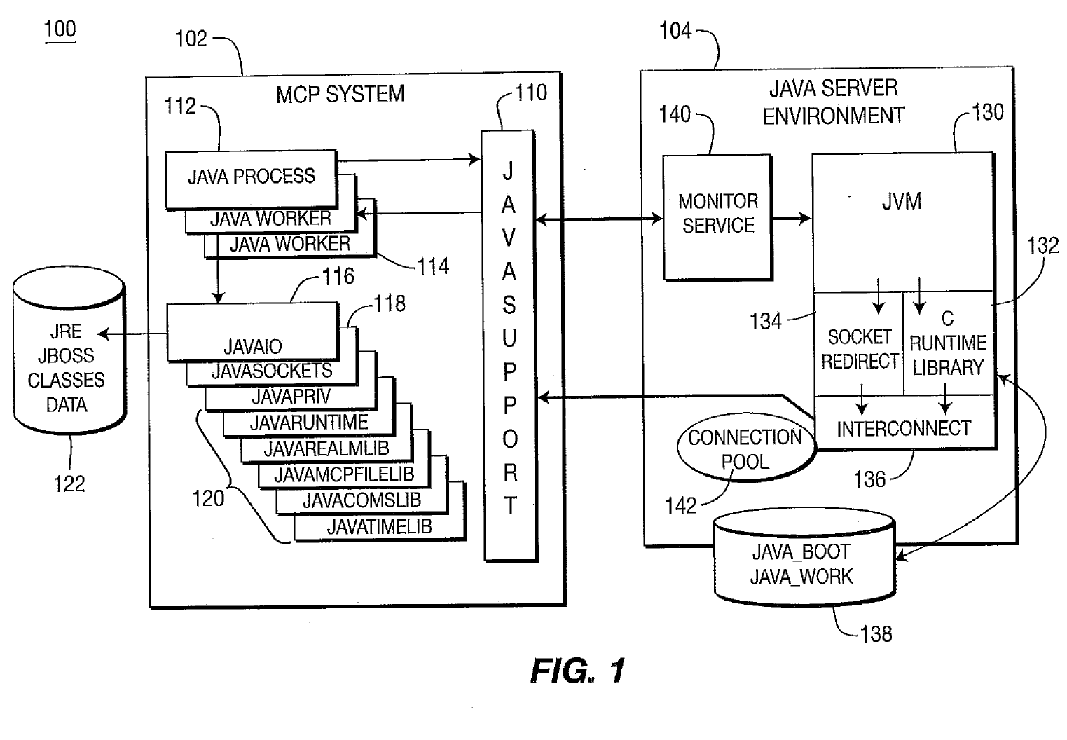

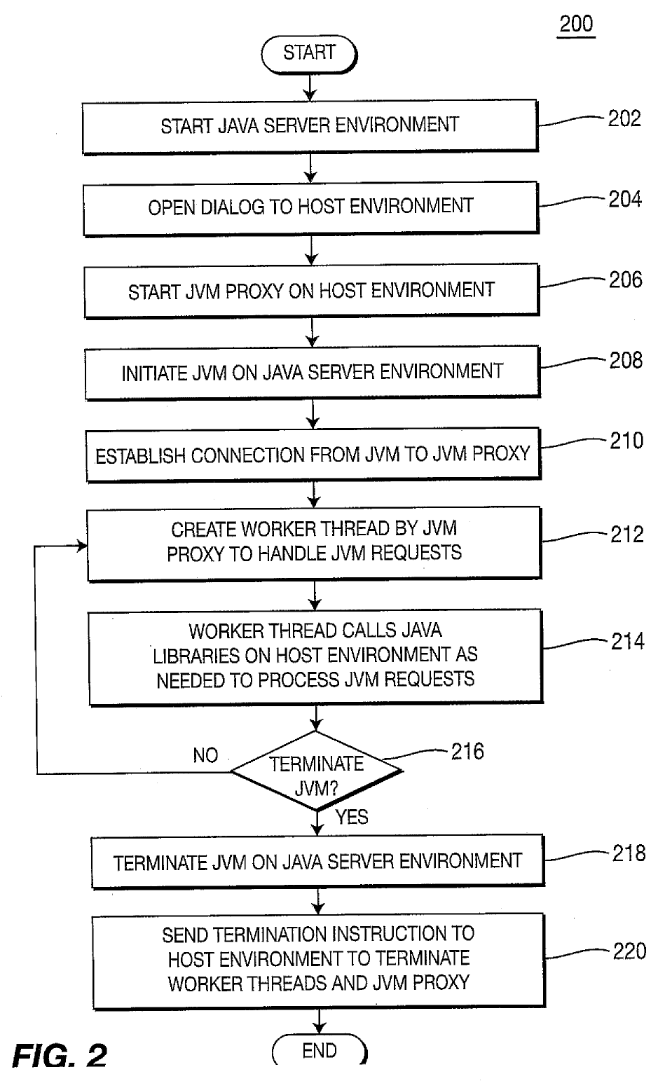

FIG. 1 is a block diagram of a system 100 showing a host environment 102 interacting with a Java server environment 104. The host environment 102 shown in FIG. 1 is an MCP system. The MCP system is exemplary, and the principles of the present invention are applicable to any host environment running any operating system. FIG. 2 is a flowchart of a method 200 showing the operation of the system 100. The operation of the system 100 will be described in conjunction with FIGS. 1 and 2 simultaneously.

The host environment 102 includes a Java support library 110, a Java process 112, a plurality of Java worker threads 114, a Java IO library 116, a Java sockets library 118, a plurality of other Java support processes 120, and a data storage 122. The Java server environment 104 includes a JVM 130, a C runtime library 132, a socket redirect library 134, an interconnect library 136, a data storage 138, a monitor service process 140, and a connection pool 142.

In operation, once the Java server environment 104 is started (step 202), the monitor service 140 attempts to communicate with the Java support library 110 to control the Java server environment 104. Once the Java support library 110 is initiated, it offers an open connection, which allows the monitor service 140 to establish a control dialog (step 204). After the control dialog is successfully created, Java applications can be executed.

To start a Java application, the Java process 112 is run on the host environment 102 (step 206). The Java process 112 is the host environment's “proxy” for the JVM 130. The Java process 112 links to the Java support library 110 and starts establishing a session. The Java support library 110 sends a message to the monitor service 140 through the control dialog to start the session and initiate the JVM 130. As part of this communication, the Java command parameters are passed from the Java process 112 to the monitor service 140. Upon successfully establishing the session, the monitor service 140 initiates the JVM 130 on the Java server 104 (step 208).

The JVM's first step is to initialize the C Runtime Library (CRT) 132. In an MCP environment, the C Runtime Library is a modified version of the Microsoft Visual C Runtime Library, MSVCRT. The CRT 132 contains the low level functions for file open, read, write, close, etc. After initializing its internal file management tables, the CRT 132 establishes a connection back to the host environment 102 through the interconnect library 136 (step 210). The interconnect library 136 provides a marshaling mechanism for converting Intel data into eMode data. The Intel data is in a different format than the eMode data, and needs to be converted via the marshaling mechanism to be usable in both environments.

The CRT 132 is modified to redirect all IO calls to the host environment 102, so that all of the IO is performed in the host environment 102. The Java applications are installed in the host environment 102, and by redirecting the IO to the host environment 102, file management advantages (such as more secure applications) are gained. This allows the Java server environment 104 to be isolated, because all the files and all the sockets (anything that is an external view) are represented on the host environment 102. Naming conventions are provided to simplify the redirection via a JAVA_BOOT directory, so some files can reside on the Windows side and eliminate having to go back and forth to the host environment 102 for the files. A field is added to the CRT file management tables to indicate the environment where the file resides. A test is performed in the appropriate CRT modules to determine whether redirection is performed.

For example, MCP files are identified by the MOP POSIX (Portable Operating System Interface) naming convention, e.g., /-/J2EE/DIR/JRE/LIB/ . . . . A Java application, however, can specify a filename by its relative path name, e.g., RT.JAR, prior to performing a low-level IO call to the JVM file system routines to establish the fully normalized file name. The CRT file management table is updated to indicate whether the file resides in the host environment 102 for subsequent read, write, or seek operations.

The initial connection from the CRT 132 through the interconnect library 136 causes the Java support library 110 to instruct the Java process 112 to create a worker thread 114 (step 212). The initial connection from the CRT 132 is used to retrieve various system information, such the initiating user's USERCODE (user ID) and the location of the data storage 122 containing the JRE and the current directory setting. It also enables the Java IO support library 116 to build its file management tables, which are used to support the IO functions in the host environment 102.

A worker thread 114 is initiated by the Java process 112 when required by the JVM 130 and is invoked using standard MCP IPC (inter-process communication). The worker thread 114 is passed an integer which identifies the worker thread and is used to create a unique name for the thread's communication path. A worker thread 114 waits for a message and calls a JVM support library 116-120 to service the request.

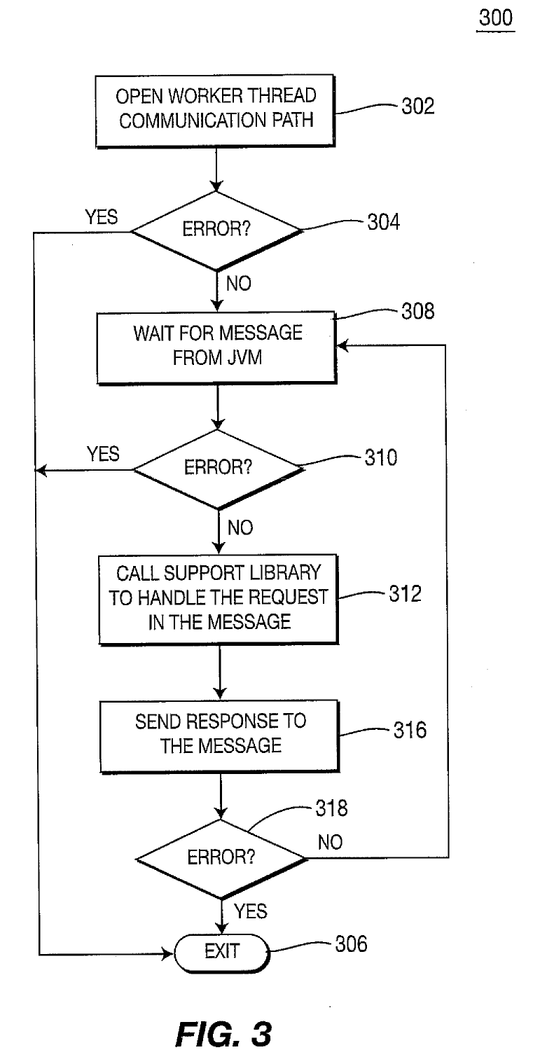

FIG. 3 is a flowchart of a method 300 showing the operation of a worker thread 114. Once created, the worker thread 114 opens a communication path via the Java support library 110 and the interconnect 136 to the JVM 130 (step 302). If there is an error in opening the communication path (step 304), the worker thread exits (step 306). After opening the communication path, the worker thread 114 waits for a message from the JVM 130 (step 308). If the worker thread encounters an error while waiting for a message (step 310), the worker thread exits (step 306). When the worker thread 114 receives a message, it calls the appropriate support library 116-120 to handle the request contained in the message (step 312). If there is an error in calling the support library, the worker thread returns an error response to the JVM (step 316). The worker thread 114 receives a response from the called library and sends the response to the message from the JVM 130 that sent the request (step 316). If there are no errors, the worker thread 114 waits for additional messages from the JVM 130 (step 308) as described above.

Referring back to FIGS. 1 and 2, depending on the request, the worker thread 114 calls a library 116-120 to process the request (step 214). In the system information example, the worker thread 114 calls the Java IO library 116, which handles all the file IO and file management requests in the host environment 102. The Java IO library 116 gathers the requested information and returns a response to the Java support library 110 through the worker thread 114. The Java support library 110 sends the response to the interconnect library 136, where the data is marshaled from eMode format into Intel format. The response is returned to the CRT 132, which forwards the response to the JVM 130.

As the JVM 130 continues to initialize, it opens various files, such as the MCPLocales file, located in the JRE in the data storage 122 on the host environment 102. Requests to open files on the host environment 102 are routed through the interconnect library 136, through the Java support library 110, to a worker thread 114, and to the Java IO library 116. The Java IO library 116 performs the requested service and returns the response.

For performance reasons, some files are located on the Java server 104, including the RT.JAR and TOOLS.JAR files. The location of these files is specified by the reserved family name JAVA_BOOT (on the data storage 138). Using the JAVA_BOOT directory permits various Java Archive (JAR) files, such as the TOOLS.JAR file, to be identified in a current path parameter using the host environment's naming conventions. The JAVA_BOOT directory is a JRE directory that is read-only from Java applications. The JAVA_BOOT area is defined as the entire directory tree under the location pointed to by the registry value ImagePath for the currently executing JVM. To access files in the JAVA_BOOT area, a Java program uses a path that starts with /-/JAVA_BOOT. The JVM file system implementation substitutes the Windows Java home directory for /-/JAVA_BOOT in the path name. For example, to include the TOOLS.JAR file in a class path, the reference would be: /-/JAVA_BOOT/lib/tools.jar.

Another special directory on the Java server 104 is the JAVA_WORK directory, which is mapped to a directory on the Java server 104 in such a way that each host environment user has a separate work area and cannot access any other user's work areas. In one implementation, the JAVA_WORK directory is mapped based on the user's running USERCODE. For security reasons, each host environment user has a different subdirectory under the JAVA_WORK directory. In this implementation, it is not possible for a Java program running under one user ID to access a Windows file created by a Java program running under a different user ID.

To access files in the JAVA_WORK area, a Java program uses a path that starts with /-/JAVA_WORK The JVM file system implementation substitutes the Windows work area parent directory, followed by a file name separator character (/), followed by the host environment user name, for /-/JAVA_WORK in the path name. For example, assume that the JAVA_WORK registry value contains the value E:\JavaWorkArea. A Java program run by user JBOSSUSER may reference the path /-/JAVA_WORK/tmp/deployfile. This path accesses the Windows file E:\JavaWorkArea\JBOSSUSER\tmp\deployfile.

The user's view of the disk areas on the Java server is restricted to the JAVA_BOOT and JAVA_WORK directories. As an example, in JBoss (a Java-based application server), the user can set the working directory to the JAVA_WORK directory. This places the workload onto the Windows side, so that back and forth access to the host environment 102 is not needed. Reducing the cross-environment access for file IO also creates a performance benefit by speeding up certain IO operations of the Java program. A further performance benefit can be gained by placing transaction and log services on the Windows side, thereby further reducing host environment access.

As the JVM 130 continues its initialization process, a socket is opened by calling the socket redirect library 134, which is a substitute for the standard WinSock library. The socket requests are routed through the interconnect library 136, like file requests to a worker thread 114, which in turn calls the Java sockets library 118 on the host environment 102. This library call invokes a link to a socket support library on MCP for the actual socket handling. Because requests for IO and socket functions can happen asynchronously, the interconnect library 136 maintains a connection pool 142 on the Java server 104. There is a one-to-one correlation between a connection and a worker thread 114, but subsequent requests to read a file, for example, do not necessarily go to the same connection and worker thread 114.

As the Java application continues its execution, additional requests can be made of host environment 102 resources. In an MCP implementation, several different libraries 122 have been created, including JAVAPRIV, JAVARUNTIME, JAVAREALMLIB, JAVAMCPFILELIB, JAVACOMSLIB, and JAVATIMELIB.

Access to the host environment 102 is based on the privileges associated with the user (in MCP, this is the user's initiating USERCODE). The monitor service 140 runs on the Java server 104 as a global service and all JVMs are initiated with that same global user identifier. All requests for MCP resources are handled by the initiating Java process 112 through the Java support library 110 connection manager and the worker threads 114.

Upon termination of the JVM 130 (steps 216 and 218), the monitor service 140 sends the JVM's exit code to the Java support library 110, which instructs the Java process 112 and all worker threads 114 to terminate (step 220). When the Java process 112 terminates, it returns the exit code to the MCP OS, which inserts it into the task's TASKVALUE.

Supporting Multiple Java Servers

The Java support library 110 maintains a list of available Windows environments. When the Java process 112 calls an initiate function, the Java support library 110 assigns a Windows environment to handle the program. The Java support library 110 identifies each JVM by a combination of a process identifier (PID) from the Java server 104 of the JVM 130 and a process number from the host environment 102 (when using MCP as the host environment, this is referred to as a MIX number) of the Java process 112. Multiple concurrent executions of the Java process 112 are identified by this pair of numbers. The Java support library 110 retrieves relevant environment information for the job. The Java support library 110 creates a message containing the initiate request, job parameters, socket number, and environment information. This message is sent to the Java monitor service 140 in the Java server environment 104. The initiate function returns successfully upon receipt of an acknowledgement from the monitor service; otherwise, it returns an error.

The Java monitor service 140 receives the initiate message from the Java support library 110 and deciphers the message, translating data as necessary. It builds an environment block from the environment information and socket number in the message. It creates a process to start the JVM 130, passing the job parameters as the command line and the environment block.

Runtime Support

MCP runtime functions are accessed by sending messages to the MCP OS. The JVM 130 calls a function in an interface DLL to access the MCP. This interface DLL creates a message to handle the function, converting any data as needed. The message is sent by calling a function in a communication DLL, which maintains a list of available worker threads 114 that handle requests. If no worker threads 114 are available, the DLL sends a message to the Java process 112 identified by its dialog ID to request a new worker thread 114. When a worker thread 114 is available, the DLL sends the function request message to that worker thread 114.

Termination

The Java program may terminate in one of three ways: normal termination, forced termination, or fault termination.

Normal termination occurs when the Java program terminates without an exception. It may have an error, but not one that causes an abnormal termination. Before normal termination, the JVM 130 sends a terminate message containing any exit codes for the process to the Java process 112. It then closes the communication channel and exits.

When a worker thread 114 receives the terminate message, it calls a function in the Java support library 110 to process the message. This function saves any exit codes and changes its state to terminating. When the communication channel closes, the Java process 112 terminates with the specified exit code. When the Java process 112 terminates, the Java support library 110 frees all resources assigned to that instance of the Java process 112.

Forced termination occurs when the Java process 112 is terminated unexpectedly, e.g., with a DS (discontinue) command from the MCP OS. Terminating the Java process 112 closes the communication channel. The JVM 130 terminates when the channel is closed.

Fault termination occurs when the JVM 130 terminates unexpectedly. The Java monitor service 140 tracks the state of the JVM 130. When the JVM 130 terminates unexpectedly, the monitor service 140 sends an abort message to the Java support library 110 containing error information on how the JVM 130 terminated.

The Java support library 110 receives the abort message and saves the error information. The Java process 112 calls a function to retrieve this information. If the function is called before the message is received, the function waits a reasonable amount of time to receive that information before returning.

When the communication channel closes without receiving a terminate message, the Java process 112 calls the function in the Java support library 110 to retrieve the error information. Upon return from the function, the Java process 112 terminates and displays the error information.

Java Monitor Service

The state of a Java server environment 104 and its jobs (i.e., JVMs) may be monitored through the Java monitor service 140, which runs on the Java server 104 (Windows, for example) to handle Java support. The monitor service 140 receives a message on its port, deciphers the message, and performs the appropriate action. It may retrieve information from the Windows OS, from a configuration database, or from a running JVM 130. The monitor service 140 communicates management information with the host environment 102 and logs relevant events in the Windows application log.

The monitor service 140 automatically begins when the Java server 104 starts. After initializing, the monitor service 140 attempts to connect to the Java support library 110 on the host environment 102 and logs the result of this attempt. If the attempt fails, the monitor service 140 periodically retries the connection (without logging) until successful. Once successful, the monitor service 140 sends a connection message to the host environment 102. This message contains the Java server number and the dialog number.

Once the connection is established, the monitor service 140 reads its control dialog for management messages, sending responses as appropriate. These management messages include:

Initiate—This message initiates the execution of a JVM 130. The monitor service 140 uses the information in the message to create a process to run the JVM 130. It sends an InitiateAck response once the JVM 130 has started. The monitor service 140 waits for the JVM 130 to complete and examines the result. If the JVM 130 terminates abnormally, it sends an abort message to the host environment 102.

Status—This message requests the monitor service 140 to send configuration information and system status information.

Terminate JVM—This message requests the monitor service 140 to terminate a JVM 130.

Dump—This message requests the monitor service 140 to cause the JVM 130 to perform a memory dump.

Job Info—This message requests the monitor service 140 to send detailed JVM process information.

The monitor service 140 may also make requests of the Java support library 110 or provide unsolicited status information to the Java support library 110. These management messages include:

JVM Terminated—This message tells the Java support library 110 that a JVM 130 has terminated.

Status Request—This message is used as a “heartbeat” to monitor the connection to the host environment 102. The lack of a response or an error response indicates that the connection has been lost. This message is also used to exchange time synchronization messages with the host environment 102. This allows the Java server 104 to maintain the same system time as the host environment 102.

Java Support Library

The Java support library 110 runs on the host environment 102 to handle Java function management. Under MCP, this is a CONTROL library that starts during MOP initialization. Once initialized, the Java support library 110 listens on its port for management messages from the monitor service 140, sending responses as appropriate. Messages handled by the Java support library 110 include:

Status Request—This message contains the configuration information and system status of a Java server 104. The Java support library 110 updates its information with the information in the status request message and records the time the message is received. If a status request message is not received from an overdue Java server 104, the Java support library 110 marks the Java server 104 as down and stops scheduling jobs on that Java server.

JVM Terminated—This message is received when a JVM 130 terminates abnormally. The Java support library 110 records any error information returned in the message for later retrieval by the initiating program.

The Java support library 110 also provides functions to interact with the Java process 112 and the worker threads 114, including:

Initiate—This function is called by the Java process 112 to initiate a JVM 130. The Java support library 110 examines its list of Java servers 104 and assigns a server to perform the job. The Java servers 104 may be assigned using one or more methods: round-robin, least-busy, or user-assigned. The Initiate message is built and sent to the Java server 104. The Java support library 110 waits a reasonable amount of time to receive an InitiateAck response. If the response is not received, or if it returns with an error, the function returns an unsuccessful response. If the response returns OK, the function returns the socket number with a successful response.

Terminate—This function is called when a Java process 112 is terminating. The Java support library 110 marks the corresponding JVM 130 as terminating and sends a Terminate JVM message to the monitor service 140.

Aborted—This function is called when the communication channel to the worker threads 114 is closed without receiving a terminate message. The Java support library 110 marks the corresponding JVM 130 as aborting. If any error information is recorded with the process, it is returned. If not, the library 110 waits a reasonable amount of time to receive the abort message from the Java server 104. If the abort message is received, the function returns the error information. If it does not receive the abort message, the function returns with an unsuccessful response.

C Runtime Library

The C Runtime Library (CRT) exports a full set of file IO functions that can operate on either the Windows file system or the MOP file system. The file system decision is based on the full path name passed to an open function and the subsequent file descriptor value.

The CRT uses an internal table to manage and track file descriptors. When a file is opened, an entry is added to the internal table, using the table index as the file descriptor returned to the application. The actual file descriptor is stored in the table along with some additional file information obtained from the OS. An indicator is added to the table to identify the OS where that file exists. In this way, the CRT can make the appropriate calls to MCP to handle the IO requests. File descriptors 0, 1, and 2 are reserved for STDIN, STDOUT and STDERR and need not be opened before use; they are automatically mapped to the MCP environment.

Windows Interconnect DLL

Service requests from the JVM 130 are intercepted and handled by the MCP OS. The Windows interconnect DLL 136 is invoked to format the parameters into a message to send to the MCP OS. This DLL has an entry point function (EPF) for every service that can be invoked. The EPF converts its parameters into eMode formats and stores them into a message. Knowledge of the message format for each service request is shared between the EPF and the corresponding function in the Java support libraries 116-120 within the MCP environment 102. The EPF formats the results into Intel format and returns them to the caller.

Two functions are provided in the interconnect DLL 136 to manage the communication paths for worker threads 114. The first function selects an available communication path and a worker thread 114 to send the message. This routine maintains a list of available paths. It selects one path, removes it from the available list, and assigns it to this function call. If no communication path is available, the function sends a message to the Java process 112 to create another communication path. The second function releases an in-use path for reassignment by placing it in the available list. The EPF uses these two functions to obtain a path to a worker thread 114. The communication paths and the corresponding worker threads 114 are closed and destroyed when they are no longer needed.

It is noted that the present invention may be implemented in a variety of systems and that the various techniques described herein may be implemented in hardware or software, or a combination of both. Although the features and elements of the present invention are described in the preferred embodiments in particular combinations, each feature or element can be used alone (without the other features and elements of the preferred embodiments) or in various combinations with or without other features and elements of the present invention. While specific embodiments of the present invention have been shown and described, many modifications and variations could be made by one skilled in the art without departing from the scope of the invention. The above description serves to illustrate and not limit the particular invention in any way.

What is claimed is:

1. A method for providing local file storage for a virtual machine running on a server, comprising the steps of:
providing a local file storage on the server;
creating a common directory on the local file storage, the common directory including files usable by the virtual machine; and
creating a private directory on the local file storage, the private directory including user files accessible only by a single user of the virtual machine, wherein each virtual machine user has a separate private directory;
wherein the common directory and the private directory are accessed via the virtual machine and a common nomenclature, whereby the implementation of the common directory and the private directory on the local file storage is hidden from the user.

2. The method according to claim 1, wherein the server is a Java server and the virtual machine is a Java virtual machine.

3. The method according to claim 1, wherein the virtual machine maps the common nomenclature to a file structure of the server.

4. A server configured to provide local file storage for a virtual machine, comprising:
a virtual machine; and
a local file storage;
wherein
the server is configured to create a common directory on the local file storage, the common directory including files usable by the virtual machine, and a private directory on the local file storage, the private directory including user files accessible only by a single user of the virtual machine, wherein each virtual machine user has a separate private directory; and
the common directory and the private directory are accessed via the virtual machine and a common nomenclature, whereby the implementation of the common directory and the private directory on the local file storage is hidden from the user.

5. The server according to claim 4, wherein the server is a Java server and the virtual machine is a Java virtual machine.

6. The server according to claim 4, wherein the virtual machine is configured to map the common nomenclature to a file structure of the server.

7. A system for providing local file storage for a virtual machine, comprising:
a server, comprising:
a virtual machine;
a local file storage, including:
a common directory, including files usable by the virtual machine; and
a private directory, including user files accessible only by a single user of the virtual machine; and
a host environment, wherein a user of the host environment requests a program to run on the virtual machine, and each host environment user has a separate private directory on the local file storage on the server.

8. The system according to claim 7, wherein the server is a Java server and the virtual machine is a Java virtual machine.

9. A computer-readable storage medium storing a set of instructions for execution by a general purpose computer to provide local file storage for a virtual machine running on a server, the set of instructions comprising:
a first creating code segment for creating a common directory on the local file storage, the common directory including files usable by the virtual machine;
a second creating code segment for creating a private directory on the local file storage, the private directory including user files accessible only by a single user of the virtual machine, wherein each virtual machine user has a separate private directory;
an accessing code segment for accessing the common directory and the private directory via the virtual machine and a common nomenclature, whereby the implementation of the common directory and the private directory on the local file storage is hidden from the user.

10. The computer-readable storage medium according to claim 9, further comprising:
a mapping code segment for mapping the common nomenclature to a file structure of the server.
